(19) United States
(12) Patent Application Publication
(10) Pub. No.: US 2005/0084816 A1
(43) Pub. Date: Apr. 21, 2005

(54) Systems and methods for performing dental operations

(76) Inventor: Bahman Moradali Mehdizadeh, Los Gatos, CA (US)

Correspondence Address: TRAN & ASSOCIATES, 6768 MEADOW VISTA CT., SAN JOSE, CA, 95135, US

(21) Appl. No.: 10/690,268

(22) Filed: Oct. 21, 2003

(51) Int. Cl. A61C 3/00

(52) U.S. Cl. 433/29; 433/75

(57) ABSTRACT

A dental device includes a housing adapted to be positioned over one or more teeth, the housing having a movable dental head adapted to access different areas of the one or more teeth; one or more cameras to capture images of the one or more teeth; one or more dental instruments coupled to the dental head to operate on the one or more teeth; and a conduit to remove debris generated during an operation.

### BACKGROUND

The present invention relates to systems and methods to perform dental operations.

In the practice of dentistry, many standard procedures require a professional such as a doctor or dentist to manipulate various instruments within the patient's mouth. For example, U.S. Pat. No. 6,257,888 notes that the cleaning or prophylaxis of the teeth should periodically be performed to remove from the teeth plaque, tartar or calculus and other matter that collects on tooth surfaces for proper dental hygiene. The cleaning procedure involves the scaling or scraping away of such matter that has adhered on surfaces of the teeth, especially those in the vicinity of the gum line and in intra-proximal regions. For this purpose, a dental hygienic technician or a dentist utilizes scalers, scrapers or picks shaped at their operative ends in various configurations designed to achieve the necessary scraping and cleaning action. Additionally, a dental mirror is a standard part of the dentist's tool kit, providing both direct and indirect views of the patient's mouth during examination and treatment, and aiding in retraction of the muscles of the tongue and inner oral cavity.

The mirror and other instruments are typically placed on instrument trays that in turn are mounted on articulated and pivotable arms permitting the tray to be positioned at a location relative to the operator and patient affording convenient access to various instruments and the like placed thereon for use in cleaning. For ridding the end of the cleaning instrument of the accumulated debris, there is ordinarily placed loosely on this tray a paper tissue, gauze pad or other absorbent wiping material with which the operator can when needed wipe the instrument end free of adherent matter.

The cleaning of the instrument exposes the professional to sharp points or edges on the instrument which are readily capable of penetrating the skin (stick). Such needle or instrument sticks can result in the transmission to the medical professional of serious diseases carried by the patients. Since viruses or bacteria from dental patients can be bourn by debris, mucous, etc. collected on the ends of cleaning instruments and transmitted to practitioner by accidental pricking or scratching of the skin with potentially serious consequences, any measure for reducing the opportunity for casual instrument sticks in the dental field is desirable.

Additionally, it is frequently necessary for the practitioner to hold the handle of the angled mirror in the one hand while the other hand is manipulating an operative instrument in order to achieve through reflection a better view of the site in the mouth being treated. Such mirrors inevitably collect moisture and “fog over” from the high humidity environment of the mouth and require periodic wiping to restore a clear view. Up until now, the mirror surface has been wiped in basically the same manner as for working instruments (other than the difference in hands) which interrupts the concentration of the practitioner and consumes valuable time.

Intraoral cameras known in the art include both stand-alone types and miniature cameras for attachment to a piece of dental equipment, such as a mirror or drill. For example, U.S. Pat. No. 6,592,371 discusses systems and methods for generating a three-dimensional (3D) model of a structure that include coating the structure with a luminescent substance to enhance the image quality, the luminescent substance having an excitation range; and capturing one or more images of the structure through at least one image aperture each having a frequency sensitivity, wherein the frequency sensitivity of each image aperture is maximized for the luminescent material emission range.

### SUMMARY

In one aspect, a dental device includes a housing adapted to be positioned over one or more teeth, the housing having a movable dental head adapted to access different areas of the one or more teeth; one or more cameras to capture images of the one or more teeth; one or more dental instruments coupled to the dental head to operate on the one or more teeth; and a conduit to remove debris generated during an operation.

In another aspect, a method for working on the teeth includes displaying images captured by the camera on a screen; receiving an input device responsive to a user command during the operation; moving the dental head in response to the user command; and actuating the dental instruments in accordance with the user command.

Implementations of the above aspects may include one or more of the following. A fluid source and a fluid conduit can be operatively connected between said fluid source and the head. The fluid source is either air or water. The one or more dental instruments include a burr, a scaler, a scraper, a pick, or a drill. The dental instruments are interchangeable. One or more light sources can be used to illuminate the teeth surfaces. The dental instruments are actuated independently of each other. A motor can be used to move the dental head. Another motor can be used to tilt the dental instruments. A joystick can be used to maneuver the head and a button can be used to activate the dental instrument.

Advantages of the system may include one or more of the following. The system is simple and safe for the professionals during operations. The system is hygienic, comfortable, effective and error-free to use; and allows easy and inexpensive maintenance. The system enhances the quality of care by creating a partnership between a person (the dental professional) and machines (motor controlled system), that seeks to exploit the capabilities of both, to do a task better than either can do alone. Machines are very precise and untiring and can be equipped with any number of sensory feedback devices. The numerically controlled dental head can move the dental instrument through an exactly defined trajectory with precisely controlled forces. On the other hand, the dental professional is dexterous and is highly trained to exploit a variety of tactile, visual, and other cues, senses, and experience to execute the procedure. Additionally, the use of digital imaging enables the dental professional to view an enlarged video image of the patient's teeth, as well as to record the image and allow the patient to view the image, if desired. Furthermore, it is possible to save images before and after treatment on a computer, or print them on a video printer.

### BRIEF DESCRIPTION OF THE DRAWINGS

The system will be readily discerned from the following detailed description of an exemplary embodiments thereof especially when read in conjunction with the accompanying drawing in which like parts bear like numerals throughout the several views.

FIG. 1 is an isometric view of an exemplary embodiment of a remote tooth preparation device having a cleaning head unit, a control module and a control computer.

FIG. 2 is a cross-sectional view illustrating the embodiment of FIG. 1 in operation.

FIG. 3A shows a side view of a dental head embodiment of the invention, while FIG. 3B shows a bottom view of the dental head of FIG. 3A.

FIG. 4 shows a cross-sectional view of the dental head of FIG. 3A as deployed in a patient's mouth.

FIG. 5 shows a side view of another embodiment for operating on teeth.

FIG. 6 shows a cross-sectional view of the embodiment of FIG. 5.

FIGS. 7A-7F show various aspects of another embodiment of the remote tooth preparation device.

### DESCRIPTION

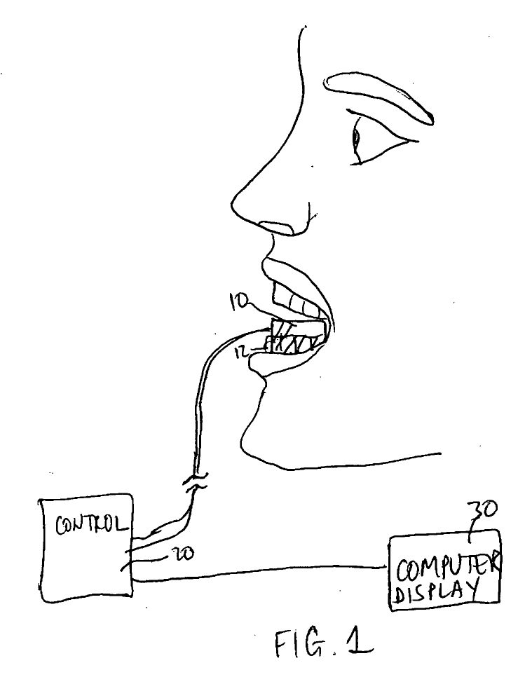

FIG. 1 is an isometric view of an exemplary embodiment of remote tooth preparation device showing a dental head unit, a control module and a control computer. As shown in FIG. 1, an intra-oral module 10 with digitally controlled cleaning head(s), digital cameras, and water sprayers are inserted onto a patient's teeth 12. Power and fluid are provided to the intra-oral module 10 through power and fluid conduits from a control module 20. Control signals and data signals are also transmitted through the control module 20. The control module 20 activates a pump to move a fluid source such as water to the intra-oral module 10. The control module 20 also activates a pump to remove fluids such as saliva and water from the patient's mouth. The control module 20 further activates one or more motors to actuate the dental head unit. The control module 20 also receives video images from cameras positioned in the intra-oral module 10 and optionally compresses the video data. The video data is then sent to a computer 30 for electronic control of the intra-oral module or for operator viewing and controlling the dental operation using the dental head unit. The control module 20, when activated, commands water spray and movements (in and out, rotate and tilt) of the dental head unit in response to a computer program or in response to manual control by an operator through the computer 30.

The operator can interface with the system using an interface device having controls such as a joystick, mouse, trackball, buttons, steering wheel, or other device physically contacted and manipulated by the user. Based on the images provided by the camera, the operator manipulates the controls which provide position or other related input data to the computer, and the computer updates the environment or program in response. In one embodiment, force feedback or tactile feedback is also provided to the operator, more generally known herein as “haptic feedback.” These devices are vibrotactile-feedback controllers which employ one or more motors coupled to the housing of the controller to shake the housing and thus provide output vibrations to the operator which are correlated to events and interactions.

During operation, an operator, for example a dentist or a dental technician, places the intra-oral module 10 in the patient's mouth. The operator then views images transmitted from the camera(s) in the intra-oral module 10 and operates an input device such as a mouse or a joystick to maneuver the dental head unit to perform a particular operation such as cleaning the patient's teeth. The dental head is remotely controlled and the operator's hands do not need to be in the patient's mouth after seating the intra-oral module 10 in the patient's mouth.

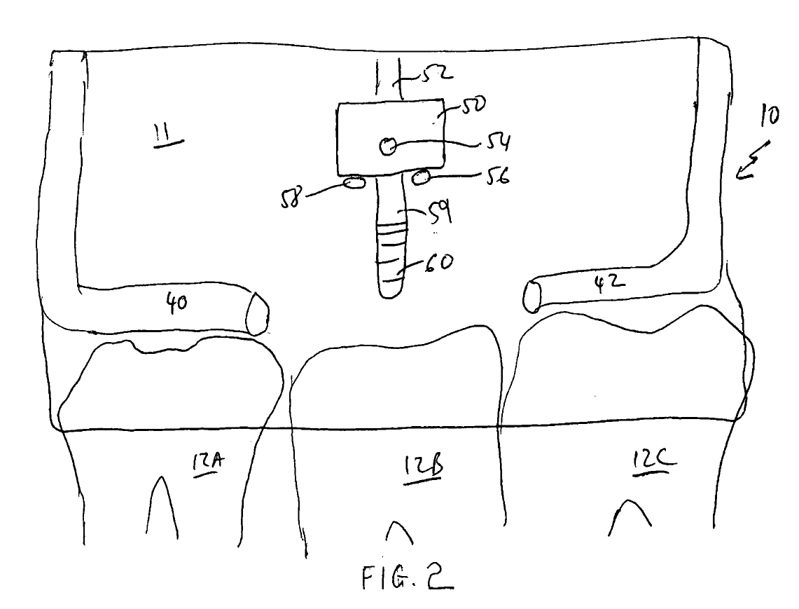

As shown in more detail in FIG. 2, the intra-oral module 10 is seated above teeth 12A, 12B and 12C. The module 10 can securely engage both the upper and lower teeth, or as shown in FIG. 2, can securely engage either the upper or the lower teeth. The module 10 defines a semi-sealed chamber 11 with minimal fluid leakage to the rest of the patient's mouth.

The intra-oral module 10 has a dental head 50 containing one or more rotating brush arms 59. Each brush arm 59 receives a brush head 60, which is replaceable when worn and is interchangeable with other polishing heads or burrs when desired. The dental head 50 is motorized to provide with reciprocable linear movement into and out of the oral cavity in order to engage the rear most teeth and all of those inbetween. Also, dental head 50 can tilt the brush arm 59 to access certain areas on the patient's teeth. It should be understood that the brush head reference is intended to apply to known dental instruments including scalers, scrapers, picks, drills and the like.

The dental head 50 has an orifice or hollow shaft 54 to inject a water stream on the teeth 12A-12C in the chamber 11. The water stream can accompany the operation of the brush head 60 to wash away the plaque dislodged from the teeth by the operation of the brush head 60 as well as providing a pulsating massage of the gums, particularly between the teeth. Water is drawn from reservoir (not shown) into a water pump, and is then forced through one end of a fluid conductor or a hollow shaft 54 embedded in a conduit 52 that connects with the dental head 50. The opposite end of the shaft 54 is actuated by a valve that is controlled by the control module 20. When the opposite end of hollow shaft 54 is opened by the control module 20, water will jet directly into the oral cavity in the chamber 11. A plurality of return fluid conduits 40-42 are connected to a pump to remove saliva and water and to deliver the return fluids directly into a drain (not shown).

The dental head 50 also includes one or more light sources 56 and one or more image apertures 58. The image aperture 58 guides images of various dental structures in the mouth to a camera or image digitizer. The digitized image is communicated to the control module 20 for eventual display on the computer 30. The computer 30 and can display images of the dental structures on a display connected to the computer 30. Alternatively, functionalities of the computer 30 such as data storage and display can be provided directly by the control module 20 in another embodiment. Images and 3D models derived from the images can be transmitted as digital files to other equipment or locations by the computer 30.

In one implementation, an image aperture is provided to capture images of the dental structures. The image aperture can be an objective lens followed by relay lens in the form of a light-transmission cable such as a fiber optic cable to transmit images of the dental structures along a pre-selected distance to a camera. The fiber optic cable transmits light through small filamentary optical materials or fibers. Typically, the fibers include a central core and an outer surrounding cladding along the entire length of the fiber. The transmission of light through the fiber is based on the phenomenon of total internal reflection. For total internal reflection, the refractive index of the core is greater than the refractive index of the cladding. In one embodiment, optical fibers for the transmission of images comprised of visible through mid-infrared light can be used.

The output of the image aperture can be provided to one or more sensors for detecting and converting incident light (photons from the light source reflected off the dental structure surface)—first into electronic charge (electrons) and, ultimately into digital bits. In one implementation, the output of the image aperture is provided to a camera (not shown), which can be analog or digital. In one embodiment, the camera contains one or more image sensor(s) used to create digital images of the dental structure. These sensors can be devices such as a charge-coupled device (CCD) sensor or a complementary metal oxide semiconductor (CMOS) image sensor. The image sensor can be an array of individual photosensitive cells (pixels) whose size determines the limiting resolution.

The light source 56 illuminates the dental structures to improve the quality or contrast of the images taken by the image aperture 58. The light can be white light, light shown in one or more colors, or can come from a laser beam. The intensity of the light source used to illuminate the dental structure is ideally controllable and is in the frequency range of visible or infra-red light. In one embodiment, the light source can be integral to the intra-oral module 10. In another embodiment, light can be routed from the light source to the head 50 by one or more fiber optic cables (not shown) embedded in the conduit 52. This bundle of optical fibers can be positioned to surround the outer circumference of the image aperture 58 to create a plurality of illuminators.

During use, images captured by the camera are displayed on a screen. The system receives an input device responsive to a user command during the operation; moves the dental head in response to the user command; and actuates the dental instruments in accordance with the user command.

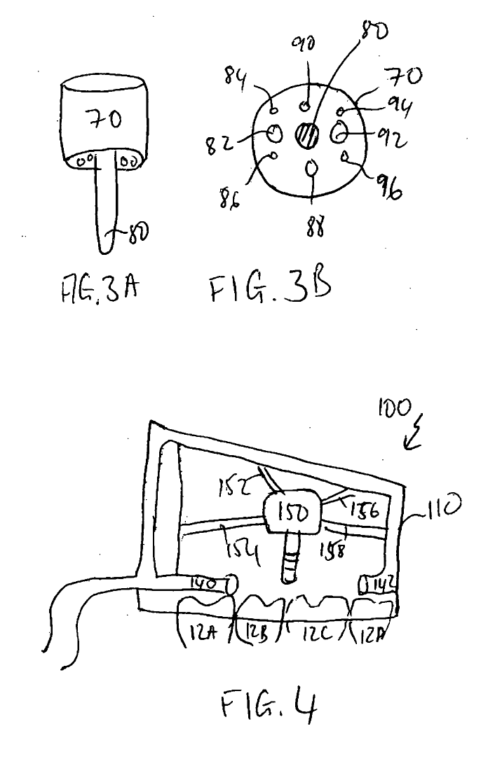

FIG. 3A shows a side view of a dental head embodiment of the invention, while FIG. 3B shows a bottom view of the brush head of FIG. 3A. A dental head 70 includes a brush head 80 projecting from the head 70. The bottom of the dental head 70 has a plurality of light sources 84, 86, 94 and 96. The bottom of the head 70 also includes orifices 88 and 90 for carrying water and air in various combinations.

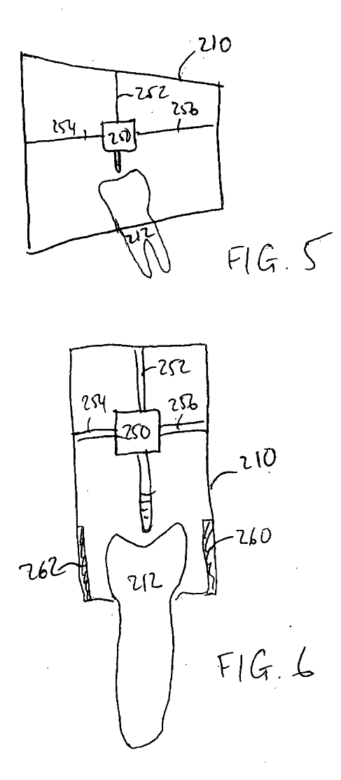

FIG. 4 shows a cross-sectional view of the dental head of FIG. 3A as deployed in a patient's mouth. In a system 100, a trapezoidal dental housing 110 is securely seated over one or more teeth. The housing 110 contains a plurality of conduits 140-142 for injecting and/or removing fluids from the housing 110 in various combinations. A dental head 150 is mounted in the housing 110. Movement of the dental head 150 is provided by gears (not shown) inside the head 150 that cooperate with threaded shafts 152-158. The gears are actuated by a motor (not shown), which in turn is controlled by the control module 20.

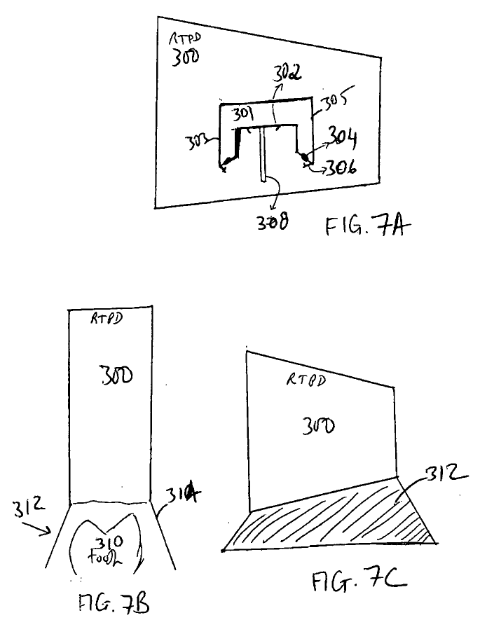

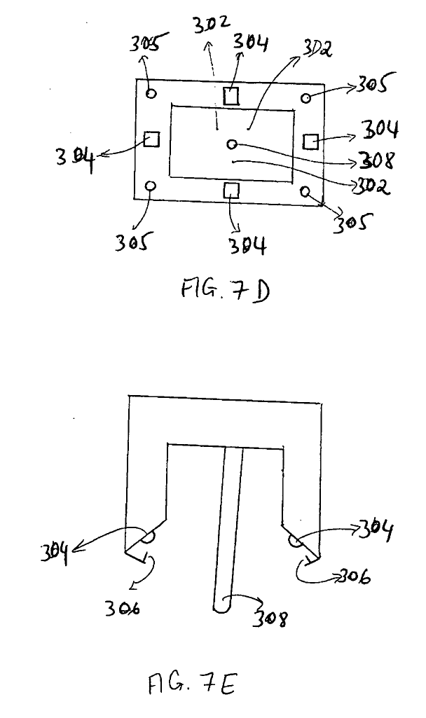

FIG. 5 shows a side view of another embodiment of an intra-oral module for operating on teeth. In this embodiment, a housing 210 takes an isosceles trapezoid where the diagonals are congruent. A dental head 250 is positioned in the housing 210 and moves along the horizontal axis using shafts 254-256. The head 250 can move along the vertical axis using a shaft 252. The dental head 250 can move horizontally and vertically to reach an area on a tooth 212. Additionally, the head 250 can tilt its brush head to get to other areas on the tooth 212. A side view of the intra-oral module of FIG. 5 is shown in FIG. 6. As shown therein, a plurality of fluid return conduits 260-262 are provided at the bottom of the housing 210 to remove unwanted fluids such as plaque filled water or saliva.

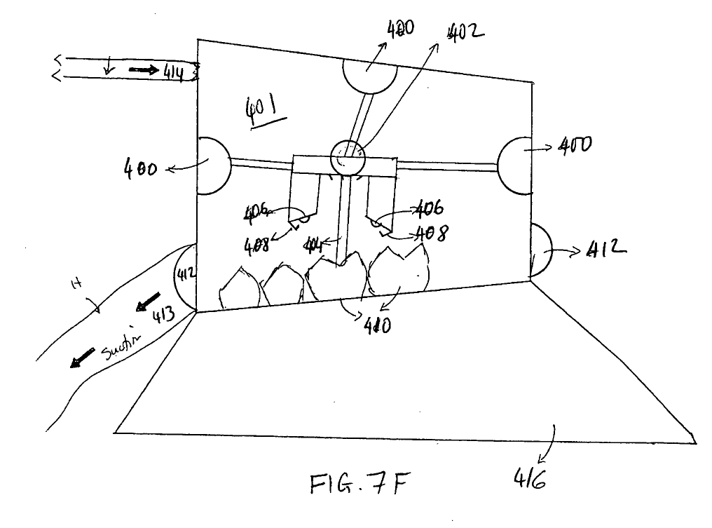

FIGS. 7A-7F illustrate a second embodiment of a remote tooth preparation device 300. A body 301 with arms 303-305 is T shaped to receive a tooth in the center of the body 301. One or more air/water spray heads 302 are positioned in the center portion of the body 301. One or more cameras 304 are positioned on the body 301 to transmit video of a tooth to a remote computer. One or more air orifices 306 are also positioned on the bottom of the body 301. Additionally, a burr 308 extends from the body 301 to contact the tooth. The movement of the burr 308 is controlled by a suitable input device such as a joystick, mouse or keyboard.

FIG. 7B shows a front view of the device 300 while FIG. 7C shows a side view of the device 300. Viewing from the front, the top portion of the device 300 is substantially rectangular in shape. Angled extensions 312-314 project from the bottom of the device 300 to protect buccal tissues as the device 300 is positioned on a tooth 310. The angled extensions 312-314 form substantially an enlarged rectangular bottom for the device 300. FIG. 7D shows a bottom view of the embodiment of FIG. 7C with the burr 308 placed at the center of the bottom of the device 300. Surrounding the burr 308 are air/water spray heads 302, cameras 304 and lights 305. FIG. 7E shows a cross-sectional view of the device 300 with cameras 304, air heads 306 (to keep dry the camera lens), and burr 308.

Turning now to FIG. 7F, the operation of an embodiment of a remote tooth preparation device 401 is illustrated. In this device, a plurality of motor assemblies 400 power a handpiece assembly 402. The motor assemblies 400 provide the handpiece assembly 402 with multiple degrees of movement freedom. A burr 404 extends from the bottom of the handpiece assembly 402 and is adapted to engage teeth 410 for cleaning or other dental operations. The handpiece assembly 402 includes one or more camera/light units 406, each of which has an air head 408 to direct a stream of air to keep moisture away from the camera's lens. The handpiece assembly 402 rests above a retractor 416. The device 401 receives air, water and/or electrical signals through a conduit 414. Water is removed through water outlets 412 on either side of the device 401.

During operation, water and air are provided to the device 401 to clean and/or lubricate the teeth 410 during a dental operation. A remote computer (not shown) receives video output of the camera/light unit 406 and processes the video. In one embodiment, the computer can perform image processing to recognize the tooth structures and to guide the burr 408 to clean or operate the teeth 410. The air stream from air heads 408 can be activated continuously or on-demand as needed to clear moisture from the lens. The computer moves the burr 404 by actuating motor assemblies 400. Plaque and other dental waste are removed by circulating water from the water inlet of conduit 414 through water outlets 412. In the embodiment of FIG. 7F, a suction tube 413 in conjunction with a pump (not shown) removes waste water from the outlets 412.

The invention has been described in terms of specific examples which are illustrative only and are not to be construed as limiting. The invention may be implemented in digital electronic circuitry or in computer hardware, firmware, software, or in combinations of them. Apparatus of the invention may be implemented in a computer program product tangibly embodied in a machine-readable storage device for execution by a computer processor; and method steps of the invention may be performed by a computer processor executing a program to perform functions of the invention by operating on input data and generating output. Suitable processors include, by way of example, both general and special purpose microprocessors. Storage devices suitable for tangibly embodying computer program instructions include all forms of non-volatile memory including, but not limited to: semiconductor memory devices such as EPROM, EEPROM, and flash devices; magnetic disks (fixed, floppy, and removable); other magnetic media such as tape; optical media such as CD-ROM disks; and magneto-optic devices. Any of the foregoing may be supplemented by, or incorporated in, specially-designed application-specific integrated circuits (ASICs) or suitably programmed field programmable gate arrays (FPGAs).

From the aforegoing disclosure and certain variations and modifications already disclosed therein for purposes of illustration, it will be evident to one skilled in the relevant art that the present inventive concept can be embodied in forms different from those described and it will be understood that the invention is intended to extend to such further variations. While the preferred forms of the invention have been shown in the drawings and described herein, the invention should not be construed as limited to the specific forms shown and described since variations of the preferred forms will be apparent to those skilled in the art. Thus the scope of the invention is defined by the following claims and their equivalents.

1. An automated intra-oral dental device, comprising:
a housing adapted to be positioned over one or more teeth, the housing having
a movable dental head adapted to access different areas of the one or more teeth;
one or more cameras to capture images of the one or more teeth;
one or more dental instruments coupled to the dental head to operate on the one or more teeth; and
a conduit to remove debris generated during an operation; and
a computer having a display to provide images captured by the camera and an input device responsive to a user input during the operation.

2. The device of claim 1, further comprising a fluid source and a fluid conduit operatively connected between said fluid source and the head

3. The device of claim 2, wherein the fluid source is either air or water.

4. The device of claim 1, wherein the one or more dental instruments include a burr, a scaler, a scraper, a pick, or a drill.

5. The device of claim 4, wherein the dental instruments are interchangeable.

6. The device of claim 1, further comprising one or more light sources.

7. The device of claim 1, wherein the dental instruments are actuated independently of each other.

8. The device of claim 1, further comprising a motor to move the dental head.

9. The device of claim 1, further comprising a motor to tilt the dental instruments.

10. The device of claim 1, wherein the input device comprises a joystick to maneuver the head and a button to activate the dental instrument.

11. A method for using a dental device including a housing adapted to be positioned over one or more teeth, the housing having a movable dental head adapted to access different areas of the one or more teeth; one or more cameras to capture images of the one or more teeth; one or more dental instruments coupled to the dental head to operate on the one or more teeth; and a conduit to remove debris generated during an operation, the method comprising:
displaying images captured by the camera on a screen;
receiving an input device responsive to a user command during the operation; and
moving the dental head in response to the user command; and
actuating the dental instruments in accordance with the user command.

12. The method of claim 11, further comprising a fluid source and a fluid conduit operatively connected between said fluid source and the head

13. The method of claim 12, wherein the fluid source is either air or water.

14. The method of claim 11, wherein the one or more dental instruments include a burr, a scaler, a scraper, a pick, or a drill.

15. The method of claim 14, wherein the dental instruments are interchangeable.

16. The method of claim 11, further comprising one or more light sources.

17. The method of claim 11, wherein the dental instruments are actuated independently of each other.

18. The method of claim 1, further comprising a motor to move the dental head.

19. The method of claim 1, further comprising a motor to tilt the dental instruments.

20. The method of claim 1, wherein the input device comprises a joystick to maneuver the head and a button to activate the dental instrument.
